(19) United States
(12) Patent Application Publication
(10) Pub. No.: US 2010/0131312 A1
(43) Pub. Date: May 27, 2010

(54) Management and Administration of Employee Eligibility Verification Forms

(75) Inventors: John F. Barnes, IV, San Antonio, TX (US); Vana Lynn Stephens, San Antonio, TX (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 12/275,857

(22) Filed: Nov. 21, 2008

(51) Int. Cl. G06Q 10/00

(52) U.S. Cl. 705/7; 705/320

(57) ABSTRACT

Methods and computer-readable media provide for the management and administration of employee eligibility forms, e.g., United States Form I-9. An I-9 Management and Administrative Program (IMAP) maintains an inventory accounting process for United States employee I-9 forms, provides a semi-automated means of contacting employees in specific circumstances using specific dates as a basis, and reports on the status of I-9 forms. An employee eligibility form may assume different medium types, including a paper format, CD-ROM, and electronic format. An employment eligibility document is received from an employee, where the employment eligibility document includes an employee eligibility verification form. The employment eligibility document is verified, and, when a discrepancy is detected, the employee is automatically notified about the discrepancy. The employment eligibility document may include at least one supporting document in order to establish the identity and employment eligibility of the employee.

### FIELD

This invention relates to the management and administration of employee eligibility forms.

### BACKGROUND

The Immigration Reform and Control Act of 1986 (IRCA) requires employers to verify that all newly-hired employees present “facially valid” documentation verifying the employee's identity and his or her legal authorization to accept employment in the United States. The I-9 form, or more properly the Employment Eligibility Verification Form, is provided by the Federal government for that purpose. Every employee hired after Nov. 6, 1986 must complete an I-9 form at the time of hire. Employees must complete Section 1 of the form within three days of starting work. The employer is responsible for ensuring that the forms are completed properly, and in a timely manner. The I-9 form is not required for unpaid volunteers or for contractors. However, a company could still find itself liable if it contracts work to a company knowing that the contractor employs unauthorized workers.

The employee must present a document, or a combination of documents that establishes both his or her identity, and his or her legal authorization to work in the United States. The IRCA includes penalties for I-9 noncompliance. According to the I-9 form, “federal law provides for imprisonment and/or fines for false statements or use of false documents in connection with the completion of this form.” An employer who hires an unauthorized worker can be fined between $250 and $5,500 per worker. In addition, such an employer can be barred from Federal government contracts for a year. An employee who knowingly accepts fraudulent documentation can also be criminally prosecuted under other immigration laws. In addition, an employer who fails to keep proper records that I-9 forms are properly filed can be fined $100 per missing item for each form, up to $1000 per form, even if the employee is legally authorized to work in the United States.

Consequently, it is important for a company to be compliant with the United States laws regarding I-9 forms. I-9 software applications are typically designed to inventory and account for I-9 forms electronically. However, software applications of this nature may be expensive and may be too broad a scope for small companies. Consequently, there is a real market need to facilitate the management and verification of I-9 forms.

### BRIEF SUMMARY

The present invention provides methods and computer-readable media for the management and administration of employee eligibility forms. An I-9 Management and Administrative Program (IMAP) maintains an inventory accounting process for United States employee I-9 forms, provides a semi-automated means of contacting employees in specific circumstances using specific dates as a basis, and reports on the status of I-9 forms. An employee eligibility form may assume different medium types, including a paper format, CD-ROM, and electronic format.

With another aspect of the invention, an employment eligibility document is received from an employee, where the employment eligibility document includes an employee eligibility verification form. The employment eligibility document is verified, and, when a discrepancy is detected, the employee is automatically notified about the discrepancy. The employment eligibility document may include at least one supporting document in order to establish the identity and employment eligibility of the employee.

With another aspect of the invention, when the employment eligibility document is expiring within a predetermined time period, a notification is sent to the employee.

With another aspect of the invention, if a necessary portion of the employment eligibility document is not received by a commitment date, a notification is sent to the employee.

With another aspect of the invention, a missing employment eligibility document is identified and a notification is consequently sent to the employee.

With another aspect of the invention an incomplete employment eligibility document is identified and a notification is sent to the employee.

With another aspect of the invention, a one-time identification is provided when a completed document for an employee has been received by the management and administrative system. A verifier uses the one-time identification to verify the validity of a supporting document.

With another aspect of the invention, a user configures a document management system for a predetermined time period. The system determines whether an event associated with employee eligibility verification form will occur within the predetermined time period and consequently generates a notification of the event. The value of the predetermined time period may be subsequently changed by the user.

### BRIEF DESCRIPTION OF THE DRAWINGS

The present invention is illustrated by way of example and not limited in the accompanying figures in which like reference numerals indicate similar elements and in which:

FIG. 1 shows a computer system used in an advanced payment integrity system in accordance with an embodiment of the invention.

FIG. 2 shows an exemplary employee eligibility verification form in accordance with an embodiment of the invention.

FIG. 3 shows a screen view when entering the I-9 Management and Administrative Program (IMAP) in accordance with an embodiment of the invention.

FIG. 4 shows a screen view when correspondence is sent regarding a missing I-9 form in accordance with an embodiment of the invention.

FIG. 5 shows a screen view when correspondence is sent regarding an expiring I-9 form in accordance with an embodiment of the invention.

FIG. 6 shows a screen view for employee data in accordance with an embodiment of the invention.

FIG. 7 shows a screen view for editing correspondence in accordance with an embodiment of the invention.

FIG. 8 shows a screen view for status reports in accordance with an embodiment of the invention.

FIG. 9 shows a screen view for obtaining documentation help in accordance with an embodiment of the invention.

FIG. 10 shows a screen view for adjusting time spans for notifications in accordance with an embodiment of the invention.

FIG. 11 shows a process for new joiners in accordance with an embodiment of the invention.

FIG. 12 shows a process for issues management in accordance with an embodiment of the invention.

FIG. 13 shows a process for expiring I-9 forms in accordance with an embodiment of the invention.

FIG. 14 shows continuation of the process shown in FIG. 13 in accordance with an embodiment of the invention.

FIG. 15 shows a process of E-Verify in accordance with an embodiment of the invention.

FIG. 16 shows a recovery process in accordance with an embodiment of the invention.

FIG. 17 shows a continuation of the process shown in FIG. 16 in accordance with an embodiment of the invention.

FIG. 18 shows a recovery process for incomplete I-9 forms in accordance with an embodiment of the invention.

FIG. 19 shows a process for verifying a supporting document in accordance with an embodiment of the invention.

### DETAILED DESCRIPTION

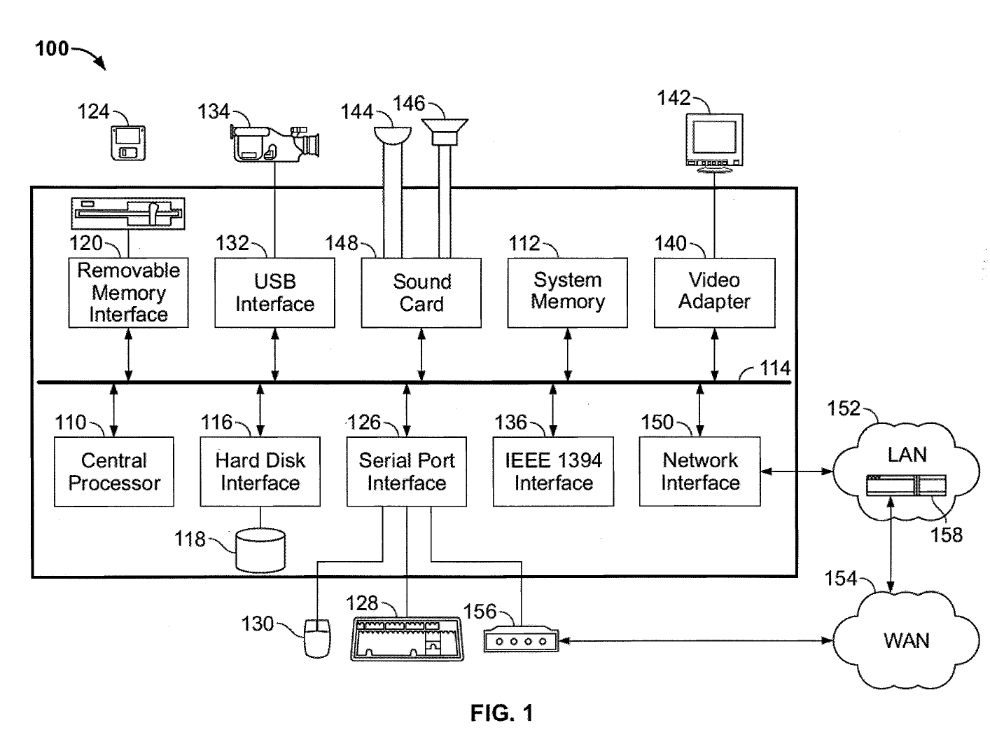

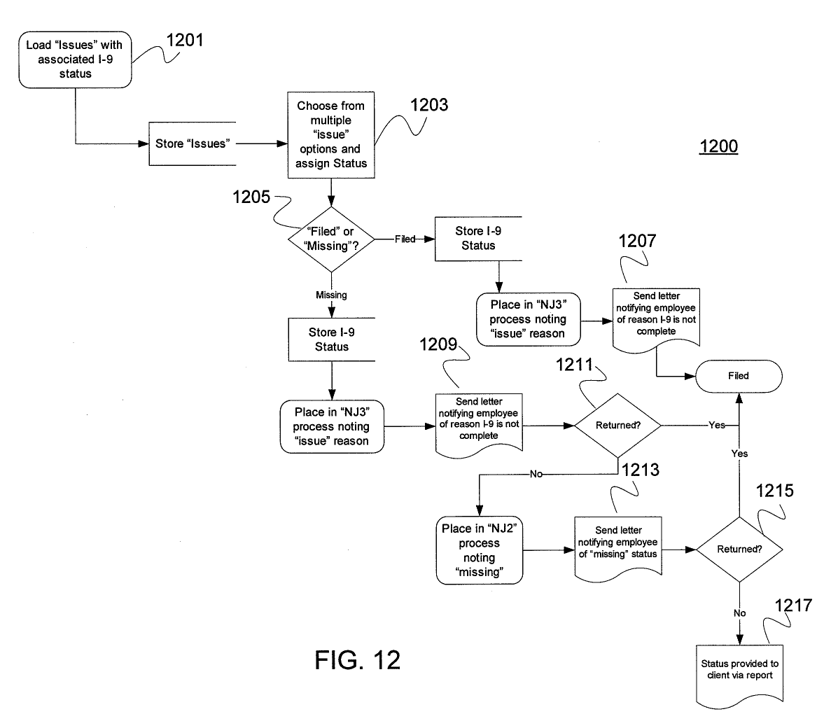

Elements of the present invention may be implemented with computer systems, such as the system 100 shown in FIG. 1. System 100 may execute a process (e.g. processes 1100-1900 as shown in FIGS. 12-19, respectively) in accordance with aspects for the invention as disclosed herein.

Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

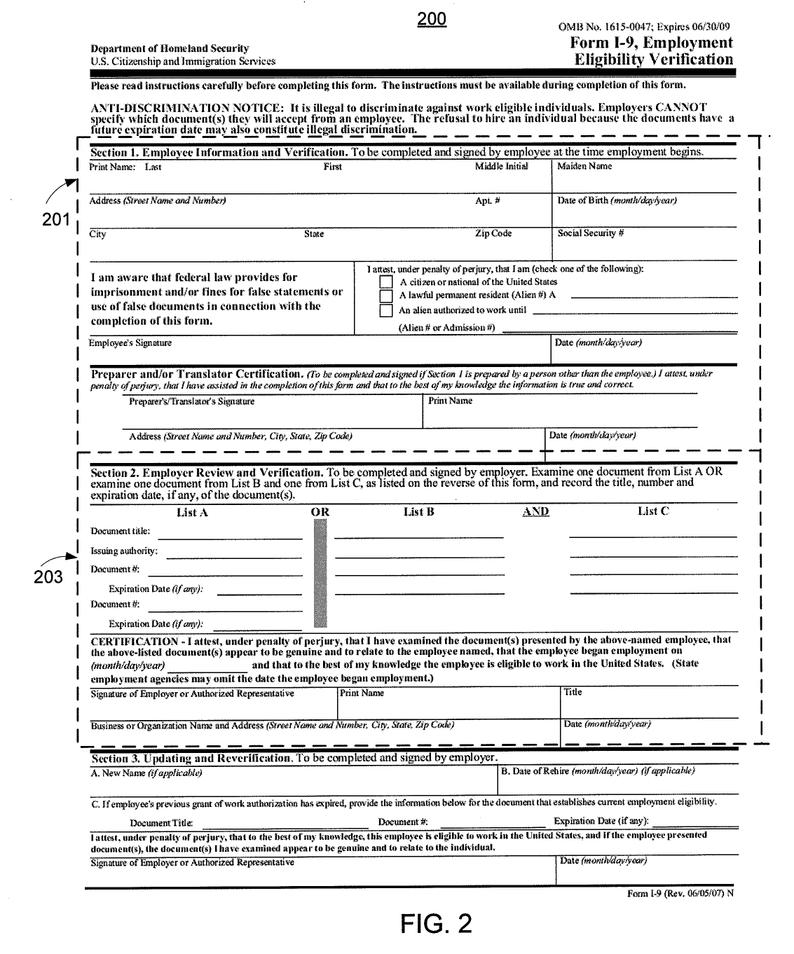

FIG. 2 shows exemplary employee eligibility verification form (e.g., United States Form I-9) 200 in accordance with an embodiment of the invention. Embodiments of the invention may process other types of employee eligibility forms for the United States and other countries. Form I-9 200 was first required by the Immigration Reform and Control Act (IRCA) of 1986. I-9 Form 200 verifies the eligibility of an employee to work legally in the United States. Employers are required to verify this employment eligibility for every employee hired. Employers who fail to obtain the appropriate documentation from new employees can be fined up to $200,000 per I-9 employment verification they fail to fill out and maintain.

It is against the law for any employer to knowingly hire employees who are not authorized to work in the United States. As part of the employment eligibility verification process, on the first day of employment, employees must provide proof that they are U.S. citizens or nationals, lawful permanent residents, or people otherwise authorized to be employed in the United States. Within three days of hire, every new employee must show their employer documentation that establishes both proof of their identity and proof of their eligibility to work in the United States.

I-9 Form 200 includes three sections, including Section 1 (201), which is completed by the employee and Section 2 (203), which is completed by the employer.

The employee completes Section 201 by including the employee's full name, social security number, date of birth, and attestation that the employee is a legal resident.

The employer completes Section 203, in which the employer reviews and verifies supporting documentation. Supporting documentation is categorized in List A, List B, and List C.

The following documents (List A) establish both identity and eligibility to work in the United States.
1. U.S. Passport (unexpired or expired.
2. Certificate of U.S. Citizenship (Form N-560 or N-561).
3. Certificate of Naturalization (Form N-550 or N-570).
4. Unexpired foreign passport, with I-551 stamp or attached Form I-94 indicating unexpired employment authorization.
5. Permanent Resident Card or Alien Registration Receipt Card with photograph (Form I-151 or I-551).
6. Unexpired Temporary ResidentCard (Form I-688).
7. Unexpired EmploymentAuthorization Card(Form I-688A).
8. Unexpired Reentry Permit (Form I-327).
9. Unexpired Refugee Travel Document (Form I-571).
10. Unexpired Employment Authorization Document issued by the Department of Homeland Security (DHS) that contains a photograph (Form I-688B).

Alternatively, an employee needs to present both proof of identity (List B) and proof of employment eligibility (List C). These documents establish an employee's identity. List C establishes an employee's eligibility to work in the United States. The following List B documents establish the employee's identification.
1. Driver's license or ID card issued by a state or outlying possession of the United States provided it contains a photograph or information such as name, date of birth, gender, height, eye color, and address.
2. ID card issued by federal, state or local government agencies or entities, provided it contains a photograph or information such as name, date of birth, gender, height, eye color, and address.
3. School ID card with a photograph.
4. Voter's registration card.
5. U.S. Military card or draft record.
6. Military dependent's ID card.
7. U.S. Coast Guard Merchant Mariner Card.
8. Native American tribal document.
9. Driver's license issued by a Canadian government authority. For persons under age 18 who are unable to present a document listed above, collect:
10. School record or report card.
11. Clinic, doctor or hospital record.
12. Day-care or nursery school record.

One of these documents (List C) must be presented in addition to the document presented from List B.
1. U.S. social security card issued by the Social Security Administration (other than a card stating it is not valid for employment).
2. Certification of Birth Abroad issued by the Department of State (FormFS-545 or Form DS-1350)
3. Original or certified copy of a birth certificate issued by a state, county, municipal authority or outlying possession of the United States bearing an official seal.
4. Native American tribal document.
5. U.S. Citizen ID Card (Form I-197)
6. ID Card for use of a Resident Citizen in the United States (Form I-179).
7. Unexpired employment authorization document issued by DHS (other than those listed under List A).

Employers must update or re-verify certain ID documents at or prior to their expiration date. This does not apply to US Passports, which can be used even if expired, nor to already presented and accepted non-expired Permanent Resident Cards when they reach their expiration date, nor to any List B documents, e.g. state driver's licenses and state IDs. The USCIS website, in the Employer section, Employer Bulletins, lists the limited requirements and allowed instances for re-verification.

In accordance with an embodiment of the invention, I-9 Management and Administrative Program (IMAP) processes Form I-9 when the employee has completed Section 1 of the form. The form may be submitted on a number of medium types, including a paper format, CD-ROM, and electronic format.

IMAP organizes the status of the I-9 forms and the employment authorization documents (EADs) automatically. The application provides the ability to view the status of the I-9 groupings via work queues. The user acts upon the work queues and the application sends correspondence to the applicable employees. All activity as to dates specific documents are recorded within the application.

The advantages of IMAP include the ability to inventory and organize all I-9 forms and supporting documentation. The added value includes the ability for multiple users to access the program and for I-9 forms to be assigned to individual I-9 specialists for case work purposes.

With an embodiment of the invention, IMAP is written in Access/SQL. However, with some embodiments, IMAP may be written in a .NET language. Consequently, the application may be browser-based, secured, and available to applicable users.

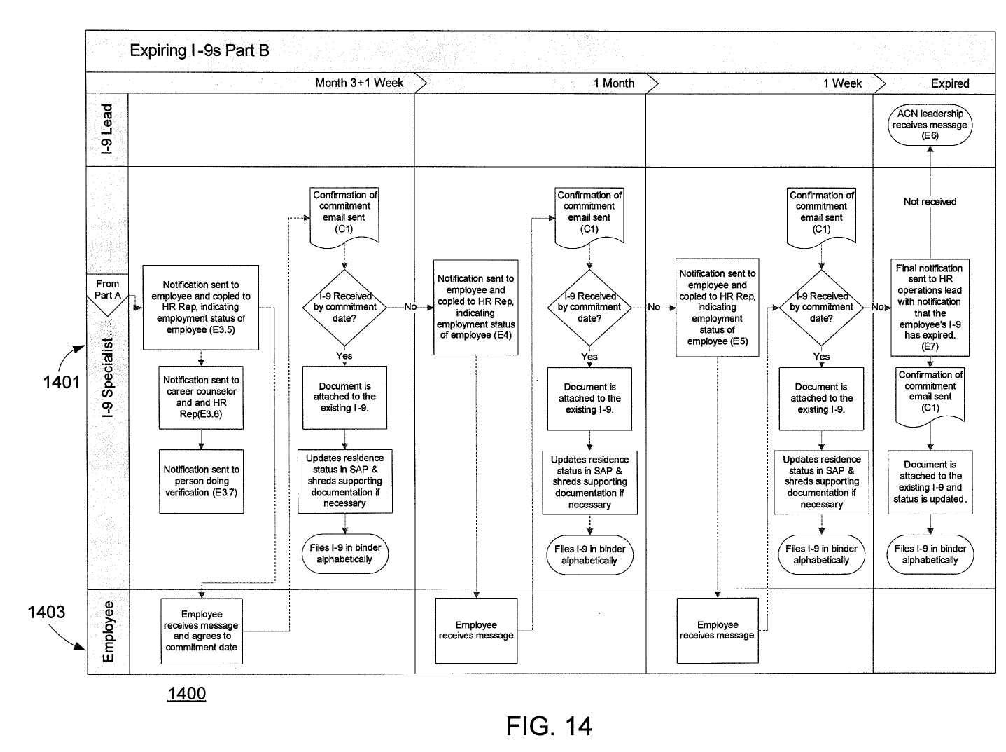

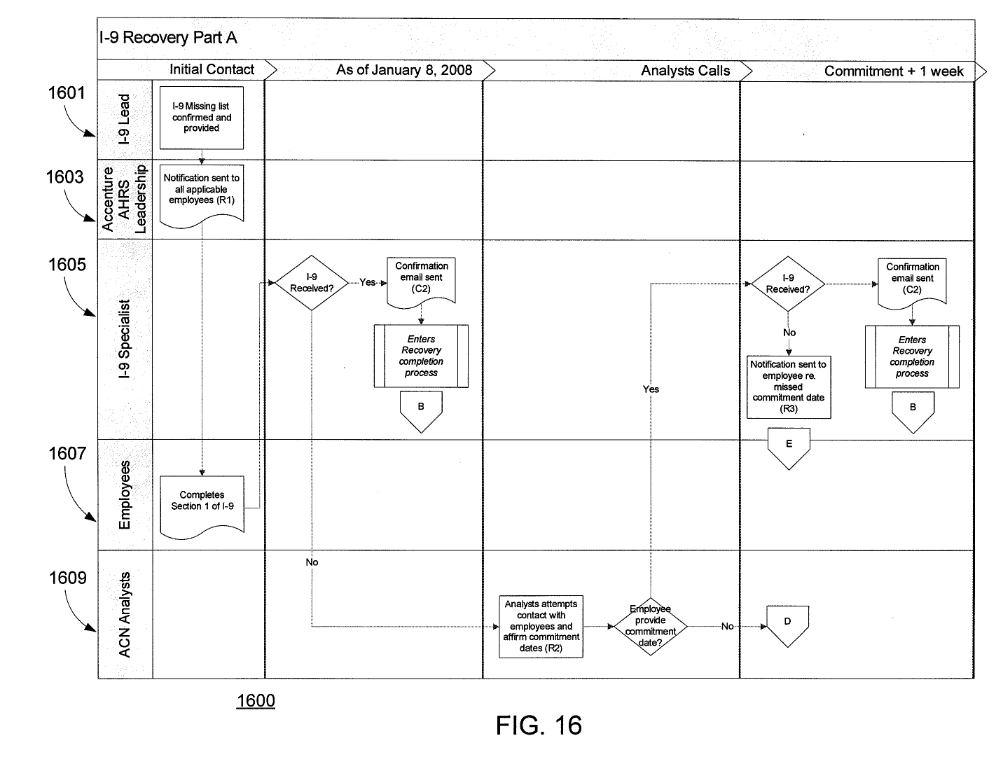

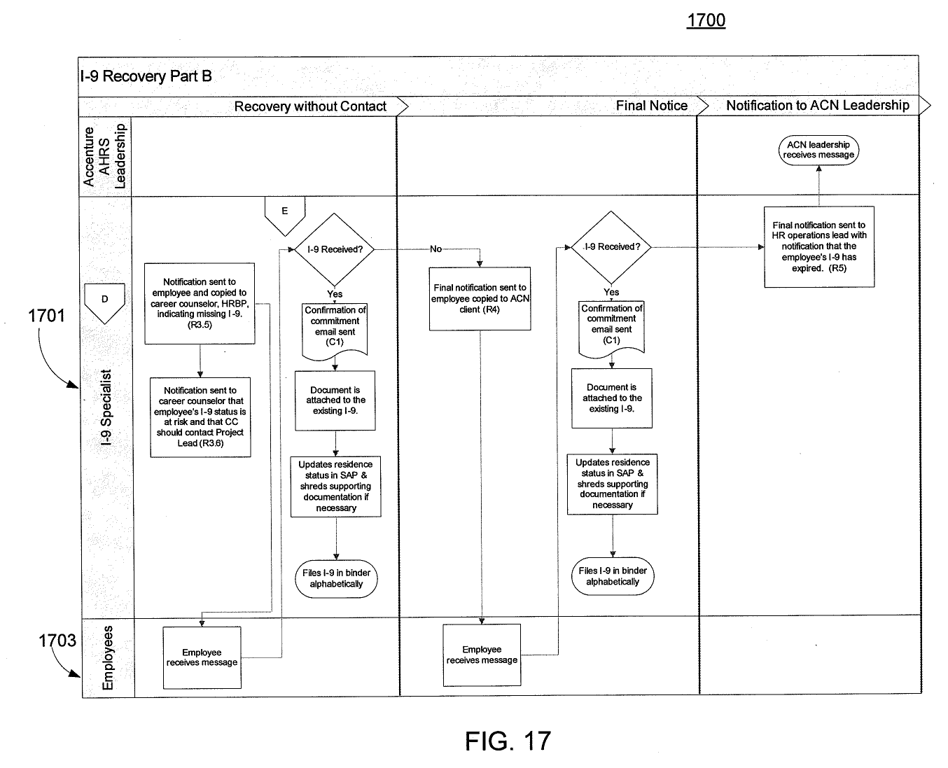

With embodiments of the invention IMAP provides the following capabilities:
Maintain an inventory accounting process for all United States employee I-9 forms, both current (active and inactive) and withdrawn
Provide a semi-automated means of contacting employees in specific circumstances using specific dates as a basis
   Missing I-9 forms (corresponding to processes 1600 and 1700 as shown in FIGS. 16 and 17, respectively)
   Expiring I-9 forms (corresponding to process 1400 as shown in FIG. 14)
Report on the status of I-9 forms
   OFCCP audits
   Internal audits
   Missing I-9s
   Expired/expiring I-9s
   Client inquiries

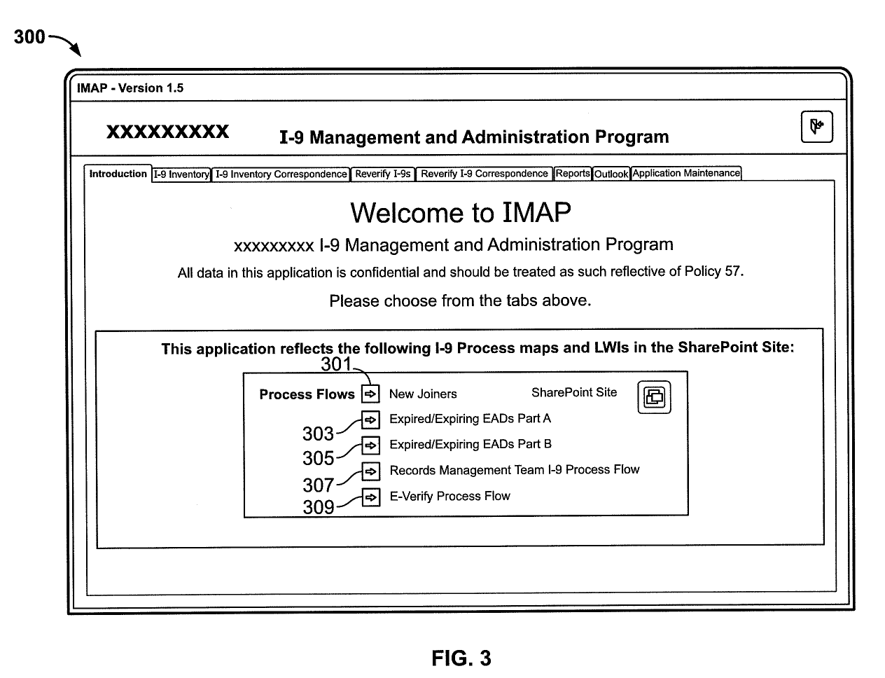

IMAP facilitates a user interface to an I-9 administrator as exemplified by the screen views shown in FIGS. 3-10.

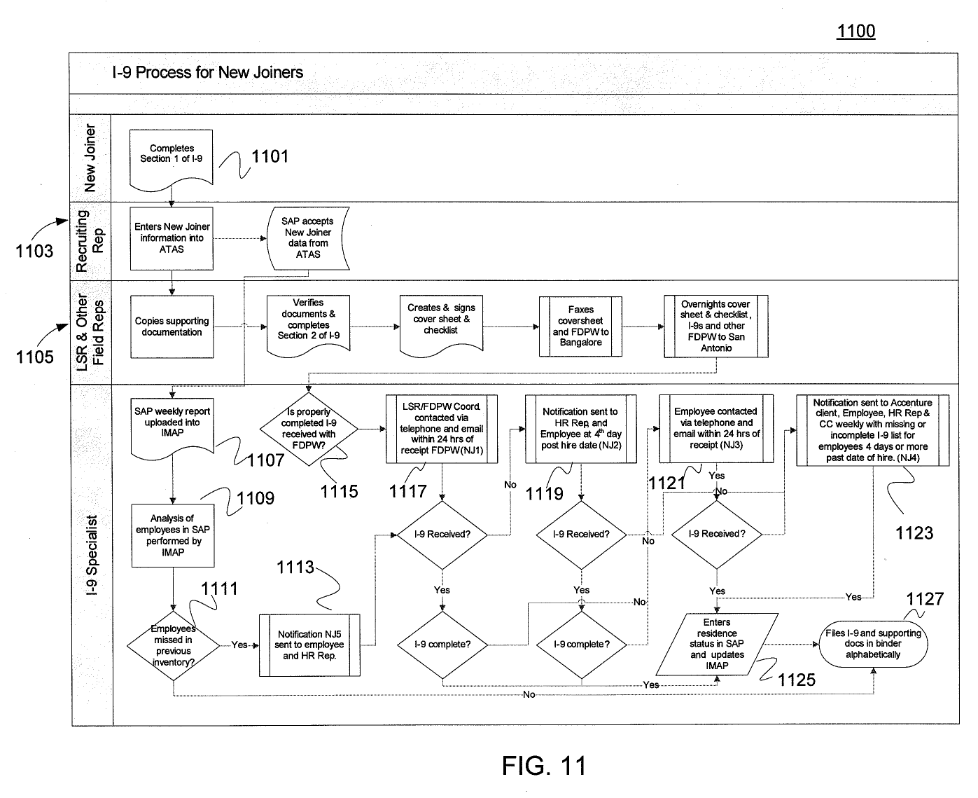

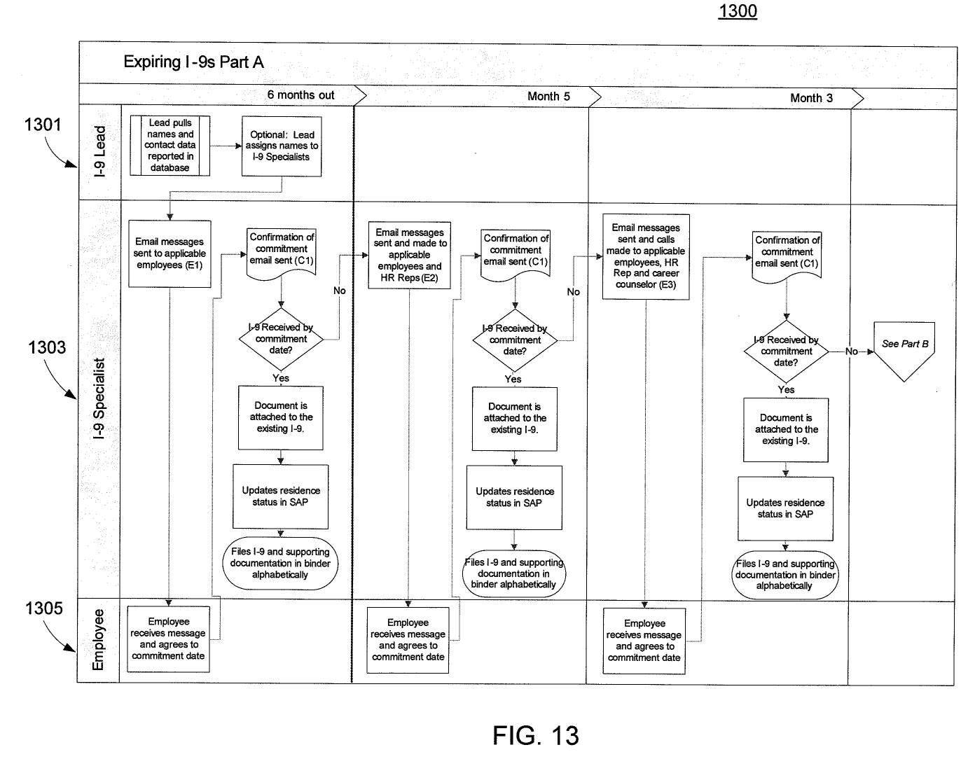

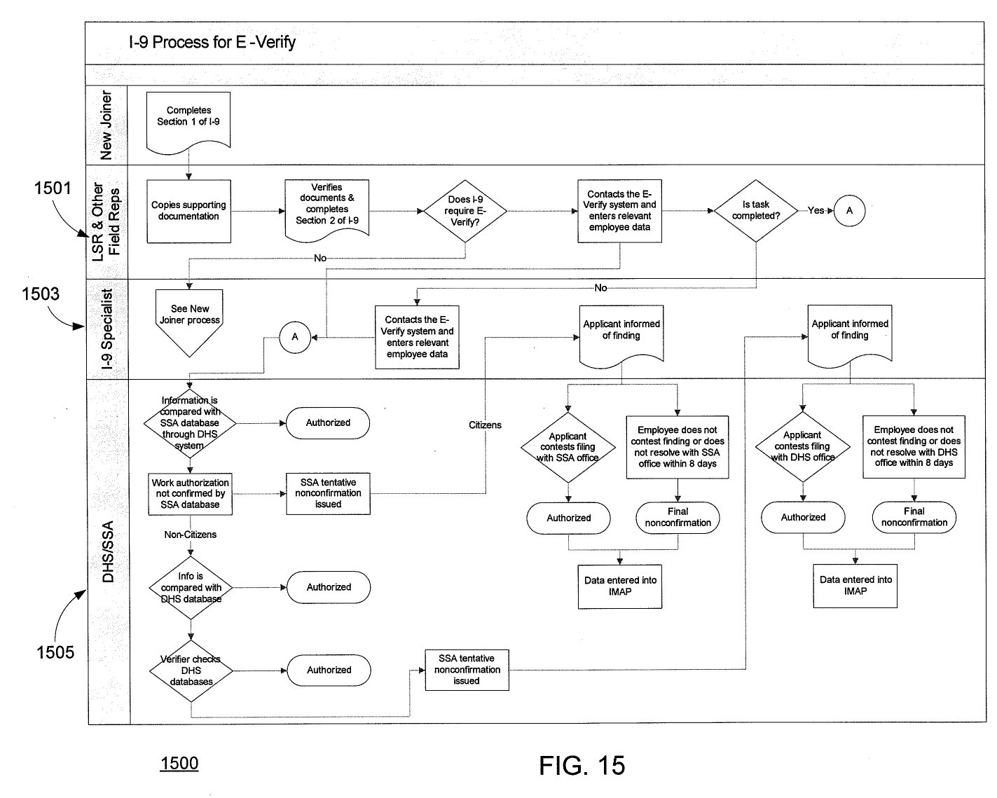

FIG. 3 shows a screen view 300 when an administrator enters the I-9 Management and Administrative Program in accordance with an embodiment of the invention. The administrator may select different process flow selections, including new joiners (301), expiring/expired EADs (303 and 305) records management 307, and E-Verify 309. As will be discussed, process flow selections 301, 303, 305, and 309 correspond to processes 1100 (FIG. 11), 1300 (FIG. 13), 1400 (FIG. 14), and 1500 (FIG. 15), respectively.

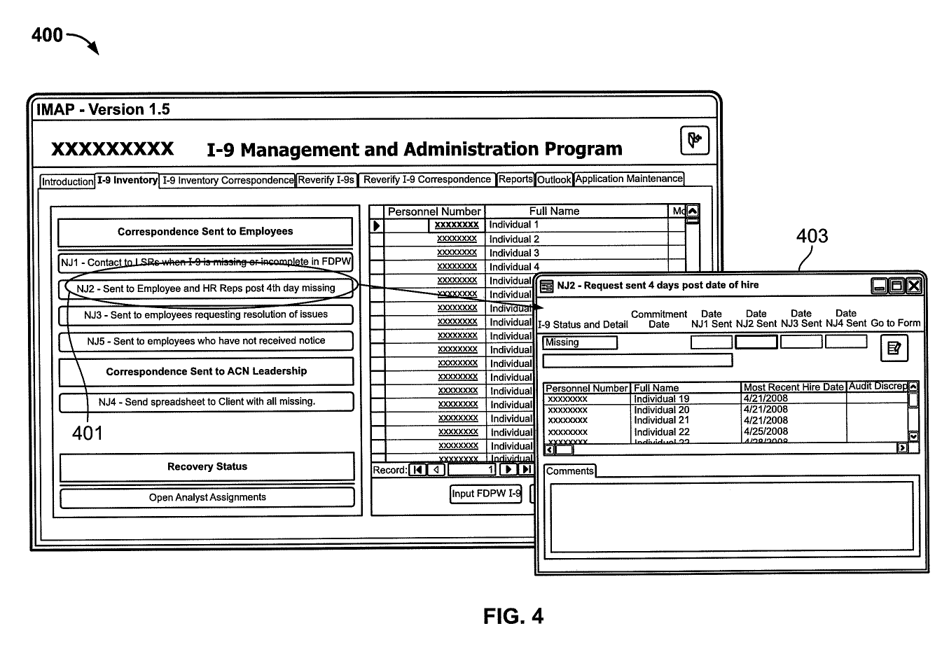

FIG. 4 shows screen view 400 when correspondence is sent regarding a missing I-9 form in accordance with an embodiment of the invention. The administrator selects selection 401 (“Sent to Employee and HR Reps post 4^{th} day missing”). This selection pertains to employees that have submitted I-9 forms by the fourth day of employment. A list of employees in which notifications have been sent are displayed in screen shot 403.

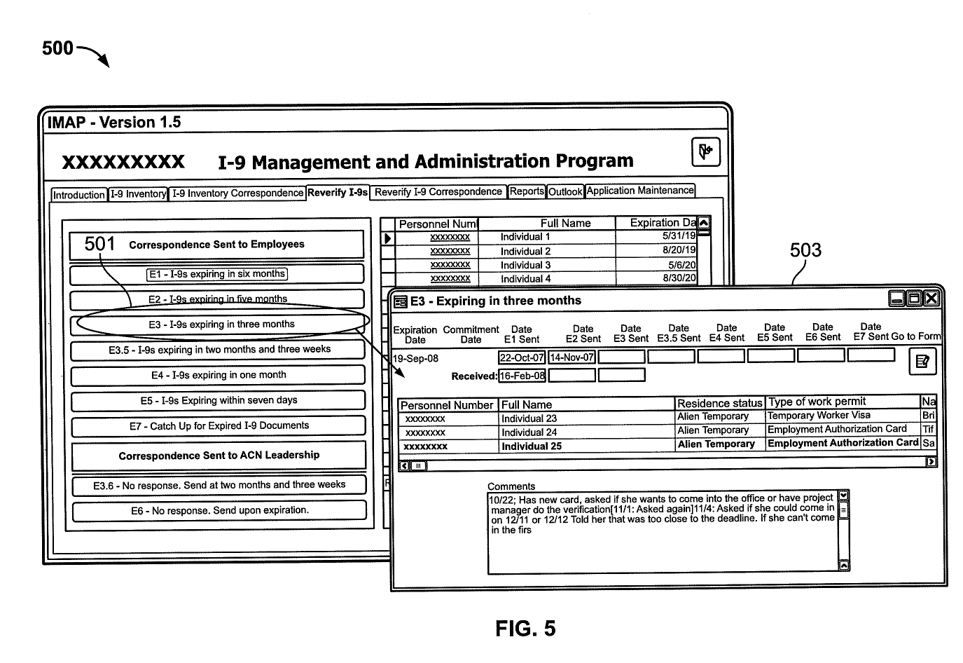

FIG. 5 shows screen view 500 when correspondence is sent regarding an expiring I-9 form in accordance with an embodiment of the invention. The administrator selects selection 501 (“I-9 s expiring in three months”). In accordance with United States regulations, employers must update or re-verify certain ID documents at or prior to their expiration date. IMAP maintains lists for different intervals, including seven days, one month, three weeks, five months and six weeks. However, IMAP may maintain lists for different intervals, as configured by the administrator. As shown in screen shot 503, a list is generated for employees for which I-9 forms are expiring.

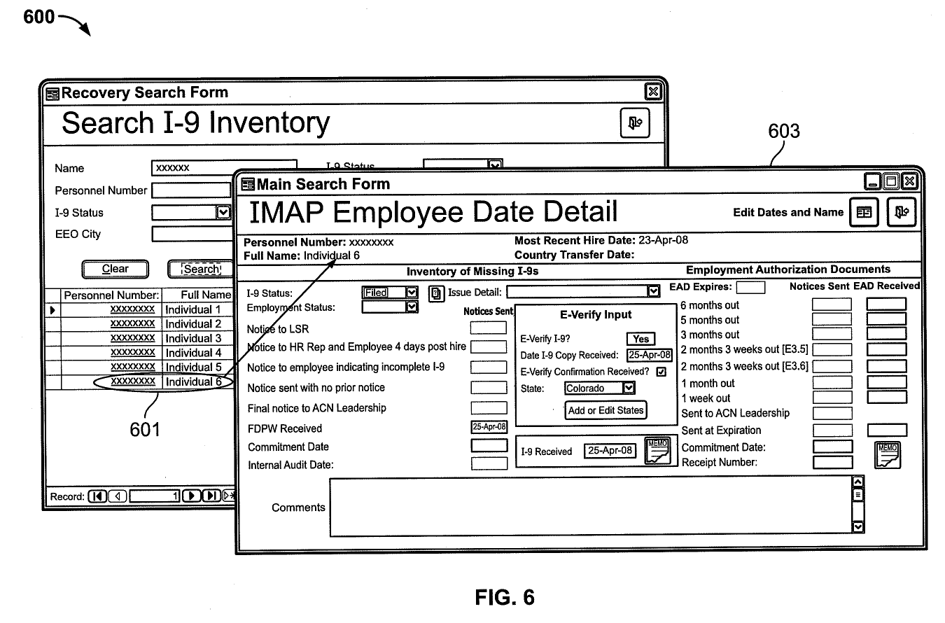

FIG. 6 shows screen view 600 for employee data in accordance with an embodiment of the invention. In the example, the administrator selects employee 601 in the I-9 inventory list. Screen shot 603 provides details for selected employee 601.

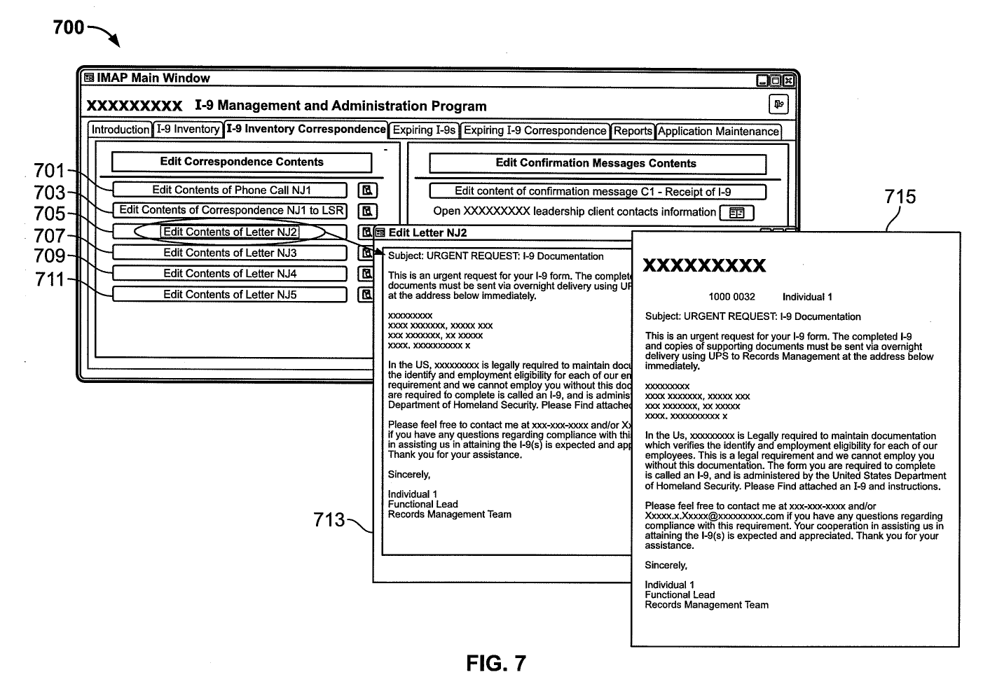

FIG. 7 shows screen view 700 for editing correspondence in accordance with an embodiment of the invention. Selections 701-711 correspond to correspondence for different I-9 events. For example, selection 701 corresponds to event “NJ2,” which is associated with step 1119 (FIG. 11) when a notification is sent at the 4^{th} day after employment if an I-9 has not been received. The administrator may modify the correspondence in screen shot 713, resulting in notification (letter) 715 being sent to an employee if the corresponding I-9 event occurs.

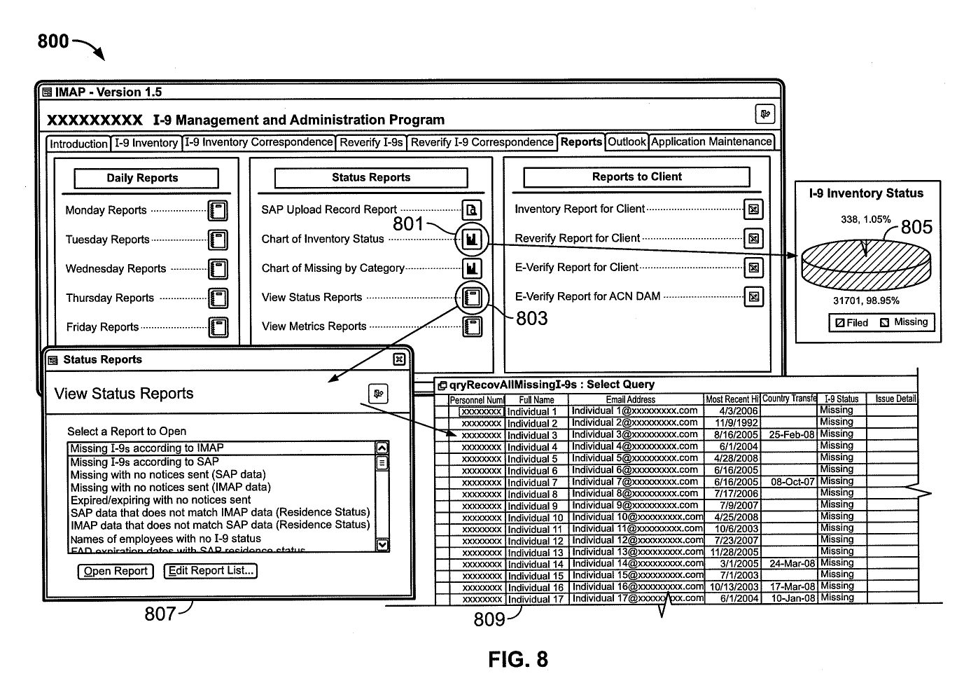

FIG. 8 shows screen view 800 for status reports in accordance with an embodiment of the invention. The administrator may select selection 801 resulting in chart 805 being displayed or selection 803 resulting in status reports 807 and 809 being displayed.

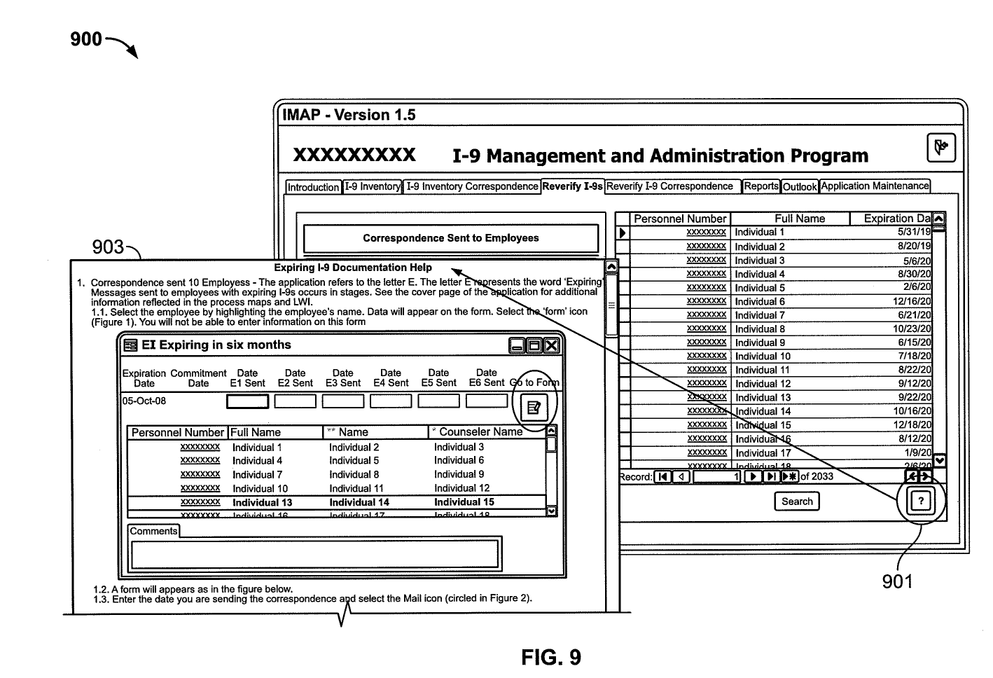

FIG. 9 shows screen view 900 for obtaining documentation help in accordance with an embodiment of the invention. In the example shown, the administrator is re-verifying I-9 forms, and consequently help selection 901 expands to documentation 903 for expiring I-9 forms.

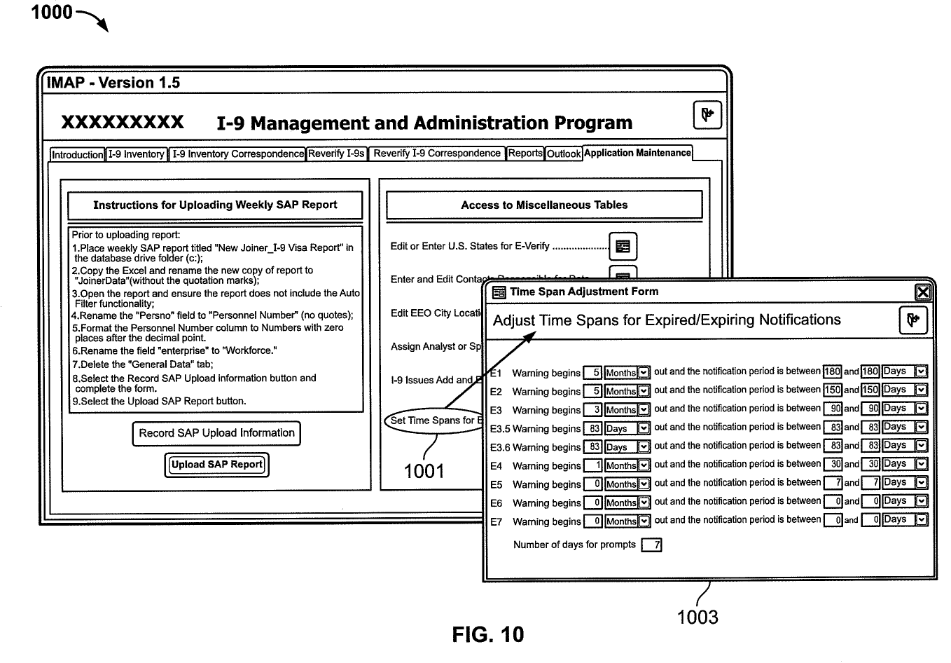

FIG. 10 shows screen view 1000 for adjusting time spans for notifications in accordance with an embodiment of the invention. The administrator may adjust time spans for expired/expiring notifications by selecting selection 1001 and configuring the time span in screen shot 1003. As shown in screen shot 1003, different I-9 events E1, E2, E3, E3.5, E3.6, E4, E5, E6, and E7 corresponding to the denoted events in FIGS. 13 and 14.

As will discussed with FIGS. 11-19, IMAP supports different functionalities including:
Indexes and accounts for the inventory of all current and terminated employee I-9 forms
Provides the user the ability to view groups of employees whose I-9 forms are missing within specified time periods
Provides the user the ability to view groups of employees with expiring documents falling within client specified time periods.
Allows the ability to search for and edit employee I-9 data
Sends user prompted letters at specific time periods to employees and career counselor or human resources (HR) representatives
   Missing
   Expiring supporting documents
   Confirmation of receipt
Once prompted
   Sends letters
   Sends spreadsheets
The application currently features over 30 various reports with filtering capabilities
Accepts a weekly upload of a standardized SAP or PeopleSoft report
Present state—fully operational, written in Access and SQL with a distinct front and back end

FIG. 11 shows process 1100 for new joiners (when an employee is first hired into a company) in accordance with an embodiment of the invention. Process 1100 is initiated when an employee (new joiner) completes Section 1 of the I-9 form. The recruiting representative enters information from the I-9 form in steps 1103. Subsequently, a filed representative verifies supporting documentation and completes Section 2 of the I-9 form in steps 1105.

In step 1107 IMAP retrieves an I-9 report and analyzes the new joiners in step 1109. If step 111 determines that the I-9 form is missing for a new joiner, a notification is sent to the employee and HR representative in steps 1113-1123 according to the type of I-9 event. If an I-9 form is received for the new joiner, the I-9 form and supporting documentation are filed in step 1127 (either from step 1111 or step 1125).

FIG. 12 shows process 1200 for issues management in accordance with an embodiment of the invention. Process 1200 is executed when I-9 event (“NJ3”: Employee contacted via telephone and e-mail within 24 hours of receipt corresponding to step 1121 as shown in FIG. 11) occurs.

FIG. 13 shows process 1300 for expiring I-9 forms (corresponding to re-verification) in accordance with an embodiment of the invention. In steps 1301, employees with expiring I-9 forms are identified. In step 1303, e-mail messages are sent to applicable employees and a commitment date is agreed upon through steps 1305. In step 1303, if supporting documentation is received, the I-9 is updated and filed. Otherwise, subsequent notifications are sent to the employee until the employee provides the necessary documentation. If the I-9 specialist is unable to obtain the necessary documentation from the employee in step 1303, process 1400 is invoked as shown in FIG. 14.

FIG. 14 shows continuation of process 1300 shown in FIG. 13 in accordance with an embodiment of the invention. In step 1401, a notification is sent both to the employee and an HR representative, indicating the employment status of the employee. In step 1403, a commitment date for resolving the expiring documentation issue is agreed upon between the I-9 specialist and the employee. As a final course of action, steps 1401 send a final notification to HR operations informing HR that the employee's I-9 form has expired.

FIG. 15 shows process 1500 of E-Verify in accordance with an embodiment of the invention. E-Verify (formerly known as the Basic Pilot/Employment Eligibility Verification Program) is an Internet based system operated by the Department of Homeland Security (DHS) in partnership with the Social Security Administration (SSA) that allows participating employers to electronically verify the employment eligibility of their newly hired employees. Usage of E-Verify is free and voluntary and is typically the best means available for determining employment eligibility of new hires and the validity of their Social Security Numbers.

In steps 1501, after receiving the I-9 form from the employee, Section 2 of the I-9 is completed and the supporting documentation is verified. If the I-9 form requires E-Verify, then steps 1503 and 1505 are executed.

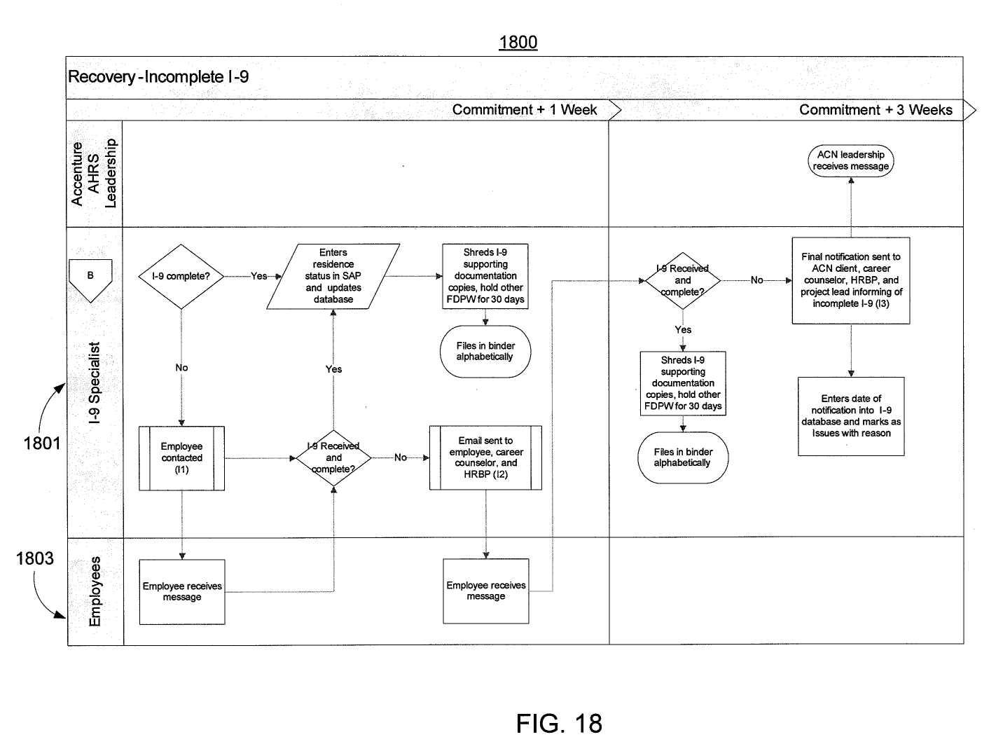

FIG. 16 shows recovery process 1600 in accordance with an embodiment of the invention. In step 1601, a list of employees with missing I-9 forms is accessed. I-9 forms may be missing for different reasons, including cases in which the employee never submitted an I-9 form or the recruiting representative did not properly enter I-9 form information into IMAP. Notification about the missing I-9 form is sent to each corresponding employee in step 1603, and the employee completes Section 1 of the I-9 form in steps 1607. If an I-9 form is received in steps 1605, steps 1801 are executed in process 1800 as shown in FIG. 18. Otherwise, the employee is contacted to affirm a commitment date in step 1609. Step 1701 of process 1700 (as shown in FIG. 17) is subsequently executed.

FIG. 17 shows a continuation of process 1600 shown in FIG. 16 in accordance with an embodiment of the invention. Steps 1701 and 1703 are executed when an employee does not provide a commitment date or if the employee missed a commitment date.

FIG. 18 shows recovery process 1800 for incomplete I-9 forms in accordance with an embodiment of the invention. Step 1801 is executed if the employee returns an I-9 form in steps 1605 in process 1600 (as shown in FIG. 16). The employee subsequently receives a message about the incomplete I-9 form in step 1803.

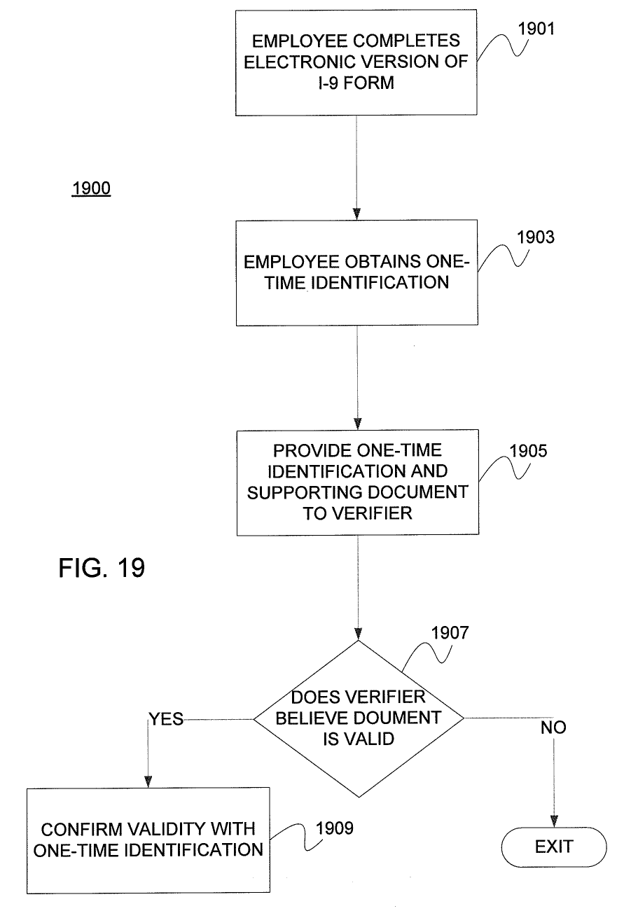

FIG. 19 shows process 1900 for verifying a supporting document in accordance with an embodiment of the invention. In step 1901, an employee completes Section 1 of the I-9 form and consequently obtains a one-time identification in step 1903. The employee then provides the one-time identification and supporting documentation (e.g., Unexpired Employment Authorization Card) to a verifier. In step 1907, if the verifier believes that the document is valid, then the verifier confirms the validity with the one-time identification and electronically signs the verification.

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A computer-assisted method comprising:
receiving a employment eligibility document from a first employee, the employment eligibility document containing an employee eligibility verification form;
verifying the employment eligibility document; and
when a discrepancy is detected, automatically notifying the first employee about the discrepancy.

2. The method of claim 1, further comprising:
when the employment eligibility document is expiring within a predetermined time period, sending a first notification to the first employee.

3. The method of claim 1, wherein the employment eligibility document includes a supporting document.

4. The method of claim 3, wherein the supporting documentation includes a first document that establishes identity and employment eligibility of the employee.

5. The method of claim 3, wherein the supporting documentation includes a first document that establishes identity of the employee and a second document that establishes employment eligibility of the employee.

6. The method of claim 1, wherein a medium of the employment eligibility document comprises paper.

7. The method of claim 1, wherein the employee eligibility verification form comprises a United States Government I-9 form.

8. The method of claim 2, further comprising:
if a necessary portion of the employment eligibility document is not received by a commitment date, sending a subsequent notification.

9. The method of claim 1, further comprising:
generating an E-Verify request for the employment eligibility document.

10. The method of claim 1, further comprising:
identifying a missing employment eligibility document for a second employee; and
sending a second notification to the second employee.

11. The method of claim 1, further comprising:
identifying an incomplete employment eligibility document for a third employee; and
sending a third notification to the third employee.

12. A computer-readable storage medium storing computer-executable instructions that, when executed, cause a processor to perform a method comprising:
receiving a employment eligibility document from a first employee, the employment eligibility document containing an employee eligibility verification form;
verifying the employment eligibility document; and
when a discrepancy is detected, automatically notifying the first employee about the discrepancy.

13. The computer-readable medium of claim 12, said method further comprising:
when the employment eligibility document is expiring within a predetermined time period, sending a first notification to the first employee.

14. The computer-readable medium of claim 13, said method further comprising:
if a necessary portion of the employment eligibility document is not received by a commitment date, sending a subsequent notification.

15. The computer-readable medium of claim 12, said method further comprising:
generating an E-Verify request for the employment eligibility document.

16. The computer-readable medium of claim 12, said method further comprising:
identifying a missing employment eligibility document for a second employee; and
sending a second notification to the second employee.

17. The computer-readable medium of claim 12, said method further comprising:
identifying an incomplete employment eligibility document for a third employee; and
sending a third notification to the third employee.

18. A computer-assisted method comprising:
providing a one-time identification when a completed document for an employee has been received, wherein the completed document includes an employee eligibility verification form and wherein the completed document is associated with a supporting document;
when the one-time identification is received, establishing communication session with a verifier; and
receiving an indication from the verifier through the communication session, wherein the indication is indicative of a validity of the supporting document.

19. The method of claim 18, further comprising:
entering the completed document through an electronic medium.

20. A computer-readable storage medium storing computer-executable instructions that, when executed, cause a processor to perform a method comprising:
providing a one-time identification when a completed document for an employee has been received, wherein the completed document includes an employee eligibility verification form and wherein the completed document is associated with a supporting document;
when the one-time identification is received, establishing communication session with a verifier; and
receiving an indication from the verifier through the communication session, wherein the indication is indicative of a validity of the supporting document.

21. The computer-readable medium of claim 20, said method further comprising:
entering the completed document through an electronic medium.

22. A computer-assisted method comprising:
configuring a document management system for a predetermined time period, wherein the document management system manages a plurality of employment eligibility forms;
determining that an event associated with one of the plurality of employee eligibility verification forms will occur within the first predetermined time period;
generating a notification of the event; and
changing a value of the predetermined time period.

23. A computer-readable storage medium storing computer-executable instructions that, when executed, cause a processor to perform a method comprising:
configuring a document management system for a predetermined time period, wherein the document management system manages a plurality of employment eligibility forms;
determining that an event associated with one of the plurality of employee eligibility verification forms will occur within the first predetermined time period;
generating a notification of the event; and
changing a value of the predetermined time period.
